(19) United States
(12) Patent Application Publication
(10) Pub. No.: US 2025/0112465 A1
(43) Pub. Date: Apr. 3, 2025

(54) TECHNIQUES FOR ADJUSTING IMBALANCE PENALTIES OF NON-DISPATCHABLE GENERATION UNITS IN ELECTRICITY MARKETS

(71) Applicant: Utopus Insights, Inc., Valhalla, NY (US)

(72) Inventors: Chanaka Keerthisinghe, Mount Wellington (NZ); Ana Rita Reis Machado da Silva, Fradelos (PT); Paulino Tardaguila Calvo, Binissalem (ES); Thomas N. Theis, Croton on Hudson, NY (US)

(73) Assignee: Utopus Insights, Inc., Valhalla, NY (US)

(21) Appl. No.: 18/478,955

(22) Filed: Sep. 29, 2023

(51) Int. Cl. H02J 3/32; H02J 3/00; H02J 13/00

(52) U.S. Cl. CPC H02J 3/32; H02J 3/004; H02J 13/00002

(57) ABSTRACT

Example systems, methods, and non-transitory computer readable media are directed to obtaining a power forecast to be provided to a grid operator of an electrical network, wherein the power forecast estimates an output of energy from power generation resources; determining a likely deviation from a nominal grid frequency during a forecast period indicating a likely imbalance penalty; determining whether to achieve a likely reduction in the imbalance penalty by (a) adjusting the power forecast or (b) controlling a battery energy storage system (BESS) associated with the power generation resources; in response to determining to achieve the likely reduction in the imbalance penalty by adjusting the power forecast: determining an adjusted power forecast; and providing the adjusted power forecast to the grid operator; and in response to determining to achieve the reduction in the imbalance penalty by controlling the BESS associated with the power generation resources: causing an adjustment to a charge rate or discharge rate of the BESS.

### FIELD OF THE INVENTION(S)

Embodiments of the present inventions relate generally to techniques for adjusting imbalance penalties of non-dispatchable generation units in electricity markets.

### BACKGROUND

An electrical grid is powered through a combination of various generation sources that produce electrical energy, which is then transmitted and distributed to homes, businesses, and industries. The electrical grid is a complex system that includes multiple components and processes to ensure a reliable and continuous supply of electricity.

The electrical grid may be powered by dispatchable and non-dispatchable generation units. Dispatchable generation units, also known as controllable generation sources, are types of electricity generation technologies that can be controlled and scheduled to produce electricity as needed by grid operators. Dispatchable generation units can be ramped up or down, turned on or off, and adjusted in response to changes in electricity demand or other system requirements. Some examples of dispatchable generation units include natural gas power plants, coal power plants, nuclear power plants, and hydroelectric power plants. In contrast, non-dispatchable generation units, also known as intermittent or variable generation sources, are types of electricity generation technologies that produce electricity based on variable and often uncontrollable factors such as weather conditions or natural processes. Unlike dispatchable generation sources, which can be controlled and scheduled to produce electricity when needed, non-dispatchable sources produce electricity when specific conditions are met, and their output cannot be easily adjusted to match changes in electricity demand. Some examples of non-dispatchable generation units include solar photovoltaic panels, wind turbines, run-of-river hydroelectric plants, and tidal and wave energy generation systems.

### SUMMARY

Example systems, methods, and non-transitory computer readable media are directed to obtaining a power forecast to be provided to a grid operator of an electrical network, wherein the power forecast estimates an output of energy from power generation resources associated with an energy producer; determining if a forecast adjustment is needed to reduce a possible imbalance penalty for the forecast period; determining whether to achieve a likely reduction in the imbalance penalty by (a) adjusting the power forecast or (b) controlling a battery energy storage system (BESS) associated with the power generation resources; in response to determining to achieve a likely reduction in the imbalance penalty by adjusting the power forecast: determining an adjusted power forecast to achieve the likely reduction in the imbalance penalty based at least in part on the obtained power forecast; and providing the adjusted power forecast to the grid operator of the electrical network; or in response to determining to achieve the likely reduction in the imbalance penalty by controlling the battery energy storage system associated with the power generation resources: causing an adjustment to a charge rate of the battery energy storage system to achieve the likely reduction in the imbalance penalty.

According to some embodiments, determining the adjusted power forecast comprises: determining an adjustment factor based at least in part on published imbalance penalties. The imbalance penalties may be published, for example, by a grid operator. According to some embodiments, determining the adjusted power forecast comprises: determining a constant adjustment factor based at least in part on historical deviations of grid frequencies associated with the electrical network; and determining a first adjusted power forecast by adjusting the obtained power forecast by the constant adjustment factor. The second adjusted power forecast may be determined, for example, by adjusting a direction and magnitude of the first adjusted power forecast, the direction and magnitude being based at least in part on a forecast of the grid frequency deviation at the time of obtaining the power forecast.

According to some embodiments, the second adjusted power forecast is calibrated to achieve a pre-defined cumulative imbalance penalty target.

According to some embodiments, determining the adjusted power forecast comprises: generating the adjusted power forecast based on a machine learning model trained against an asymmetric loss function, wherein the machine learning model is trained to penalize over-forecasts or under-forecasts based at least in part on historical deviations of grid frequencies associated with the electrical network.

According to some embodiments, determining the adjusted power forecast comprises: determining that a cumulative error of a plurality of adjusted power forecasts reduces average forecast accuracy below that of a reference forecast obtained from the grid operator; and halting further adjustments to the power forecast in response to the determination.

According to some embodiments, causing the adjustment to the charge level of the battery energy storage system to achieve the likely reduction in the imbalance penalty comprises: causing the battery energy storage system to charge based at least in part on a forecast of grid frequency deviation associated with the electrical network and an adjustment factor.

According to some embodiments, causing the adjustment to the charge level of the battery energy storage system to achieve the likely reduction in the imbalance penalty comprises: causing the battery energy storage system to discharge based at least in part on a forecast of grid frequency deviation associated with the electrical network and an adjustment factor.

According to some embodiments, the systems, methods, and non-transitory computer-readable media are directed to determining that a running cumulative imbalance penalty exceeds a cumulative imbalance penalty target by a threshold amount; and ceasing further adjustments to the charge level of the battery energy storage system in response to the running cumulative imbalance penalty exceeding the cumulative imbalance penalty target by the threshold amount.

According to some embodiments, the imbalance penalty corresponds to a causer pays factor (CPF) value.

Some systems, methods, and non-transitory computer readable media are directed to obtaining a power forecast to be provided to a grid operator of an electrical network, wherein the power forecast estimates an output of energy from power generation resources associated with an energy producer; determining if a forecast adjustment is needed to reduce a possible imbalance penalty during the forecast period; determining an adjusted power forecast to achieve the possible reduction in the imbalance penalty based at least in part on the obtained power forecast; and providing the adjusted power forecast to the grid operator of the electrical network.

Example systems, methods, and non-transitory computer readable media are directed to obtaining a power forecast to be provided to a grid operator of an electrical network, wherein the power forecast estimates an output of energy from power generation resources associated with an energy producer; determining if a forecast adjustment is needed to reduce a possible imbalance penalty during the forecast period; and causing an adjustment to a charge rate or discharge rate of a battery energy storage system (BESS) associated with the power generation resources to achieve a likely reduction in the imbalance penalty.

According to some embodiments, the systems, methods, and non-transitory computer readable media are directed to determining a schedule for adjusting the charge rate or charge discharge of the battery energy storage system associated with the power generation resources over a time interval; and providing the schedule for adjusting the charge rate or discharge rate of the battery energy storage system to the grid operator.

### BRIEF DESCRIPTION OF THE DRAWINGS

FIG. 1A depicts a block diagram of an example of an electrical network according to some embodiments.

FIG. 1B depicts a block diagram of an example interaction between an electrical network and an energy producer according to some embodiments.

FIG. 2 depicts a block diagram of components of an energy producer engine according to some embodiments.

FIG. 3 depicts an example static approach for adjusting power generation forecasts according to some embodiments.

FIG. 4 depicts an example dynamic approach for adjusting power generation forecasts according to some embodiments.

FIG. 5 depicts yet another example dynamic approach for adjusting power generation forecasts according to some embodiments.

FIG. 6 depicts an example graphical distribution of historical frequency indicator (FI) values corresponding to an energy grid operator.

FIG. 7 depicts an example static approach for adjusting power generation forecasts in energy markets where imbalance penalties are based on cause pays factor (CPF) calculations according to some embodiments.

FIG. 8 depicts an example dynamic approach for adjusting power generation forecasts in energy markets where imbalance penalties are based on CPF calculations according to some embodiments.

FIG. 9 depicts yet another example dynamic approach for adjusting power generation forecasts in energy markets where imbalance penalties are based on CPF calculations according to some embodiments.

FIG. 10 depicts example equations that may be implemented to control a battery energy storage system (BESS) using frequency indicator (FI) predictions according to some embodiments.

FIG. 11A illustrates an example process according to some embodiments.

FIG. 11B illustrates another example process according to some embodiments.

FIG. 11C illustrates yet another example process according to some embodiments.

FIG. 12 is a block diagram illustrating a computing device in one example.

### DETAILED DESCRIPTION

An electrical grid is typically designed to operate at a specific nominal frequency, such as 50 Hz. Grid operators aim to keep the frequency as close as possible to this nominal value under normal conditions. Various factors, including fluctuations in electricity demand and supply, can cause deviations in grid frequency. If the frequency deviates too far from the nominal value, it can lead to grid instability, equipment damage, and even blackouts.

To help prevent such deviations, owners of power generation systems, whether they are large utility-scale facilities or smaller distributed energy resources, typically provide power generation forecasts (or power forecasts) to grid operators. A power generation forecast is a prediction of the future electricity output from various power generation sources. It provides valuable information for grid operators to ensure reliable, efficient, and stable operation of the electrical grid. For example, accurate power generation forecasts help grid operators plan and manage the balance between electricity supply and demand. Accurate power generation forecasts can also help grid operations with resource planning. For instance, by knowing in advance how much power various generators are expected to produce, they can optimize the use of available resources, including fossil fuel power plants, renewable energy sources, and energy storage systems. The need for accurate power generation forecasts is especially important for non-dispatchable (or renewable) energy sources like wind and solar, whose power outputs are inherently variable. Owners of renewable energy facilities may regularly provide forecasts to help grid operators incorporate these variable sources into the grid reliably. Forecasting helps grid operators predict when and how much renewable energy will be available.

In some instances, grid operators may levy imbalance penalties on owners of power generation systems for providing inaccurate power forecasts. An imbalance penalty, in the context of energy markets and electricity grid operations, is a financial charge imposed on market participants or grid users when their actual electricity consumption or generation deviates from what was previously scheduled, contracted, or expected. These penalties are used to incentivize accurate scheduling, promote grid stability, and encourage responsible electricity consumption and generation practices.

The calculation of imbalance penalties by grid operators can vary depending on the specific rules and regulations of the energy market and the balancing authority responsible for managing the grid. As an example, some energy markets, such as the Australian Energy Market Operator (AEMO), which sets market rules for Australia's National Electricity Market, use frequency deviations from a nominal grid frequency to determine imbalance penalties for inaccurate power forecasts. In this energy market, owners of power generation systems are penalized for deviations from their forecasted generation if they are a causer, as opposed to a helper, of the frequency deviation. Other approaches for calculating imbalance penalties are possible.

Imbalance penalties can decrease the revenue of owners of non-dispatchable generation units (i.e., energy producers) given that it is very difficult to accurately forecast power generation from naturally variable resources, such as wind and solar. Even though an improved forecast can reduce the imbalance penalties, it can never reduce these penalties to zero in the absence of perfect foresight. Therefore, other methods for reducing imbalance penalties are desirable from the viewpoint of owners of non-dispatchable power generation resources.

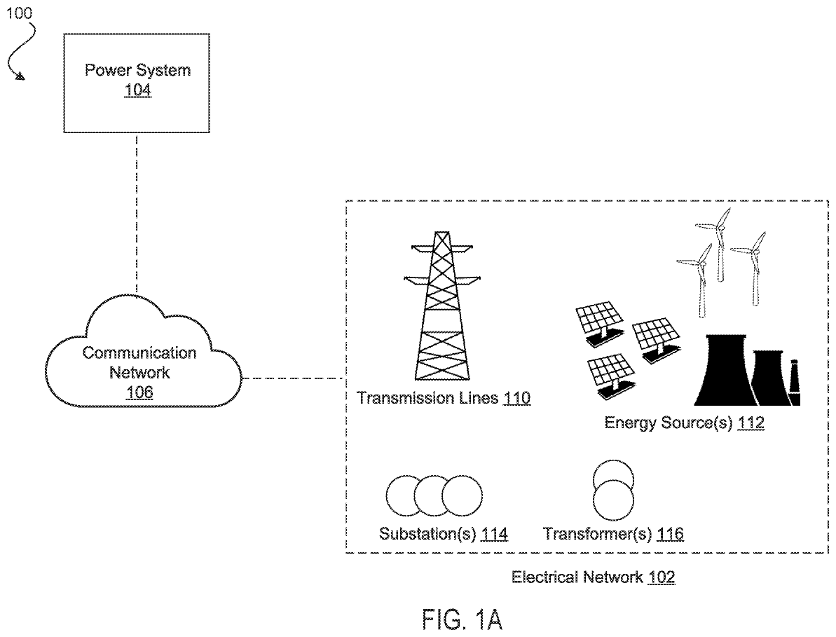

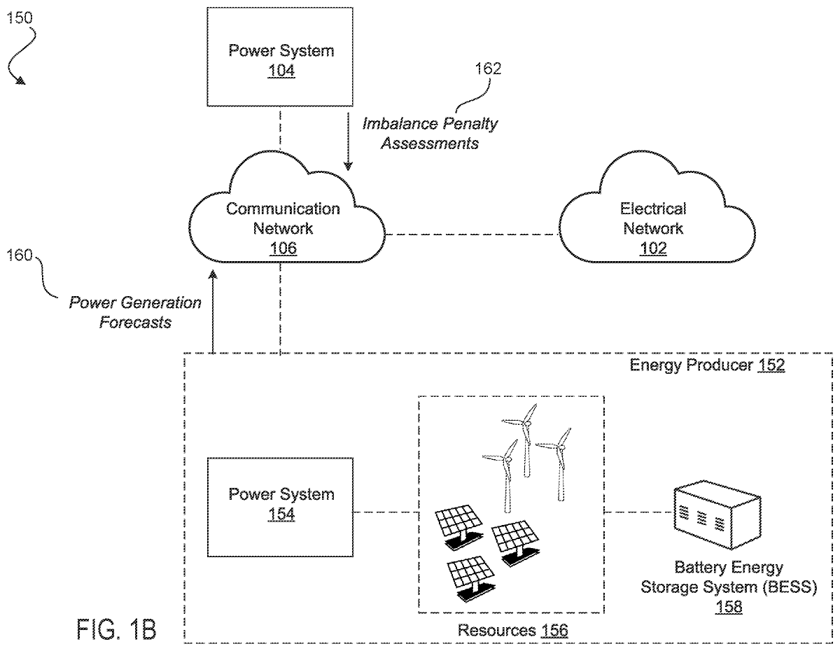

FIG. 1A depicts a block diagram 100 of an example of an electrical network (or grid) 102, according to some embodiments. FIG. 1A illustrates the electrical network 102 in communication with a power system 104 over a communication network 106. The electrical network 102 includes any number of transmission lines 110, energy sources 112, substations 114, and transformers 116. The electrical network 102 may include any number of electrical assets, including protective assets (e.g., relays or other circuits to protect one or more assets), transmission assets (e.g., lines, or devices for delivering or receiving power), and/or loads (e.g., residential houses, commercial businesses, and/or the like).

Components of the electrical network 102 such as the transmission line(s) 110, the energy source(s) 112, substation(s) 114, and/or transformer(s) 116 may inject energy or power (or assist in the injection of energy or power) into the electrical network 102. Each component of the electrical network 102 may be represented by any number of nodes in a network representation of the electrical network 102. The energy sources 112 may include renewable energy sources (e.g., solar panels, wind turbines, and/or other forms of so called “green energy”) and non-renewable energy sources (e.g., gas power plants, nuclear power plants, and/or the like). The electrical network 102 may include a wide electrical network grid with thousands of assets or more.

Each component of the electrical network 102 may represent one or more elements of their respective components. For example, the transformer(s) 116, as shown in FIG. 1, may represent any number of transformers that make up electrical network 102.

In some embodiments, communication network 106 represents one or more computer networks (e.g., LAN, WAN, and/or the like). Communication network 106 may provide communication between the power system 104 and the electrical network 102. In some implementations, communication network 106 comprises computer devices, routers, cables, and/or other network topologies. In some embodiments, communication network 106 may be wired and/or wireless. In various embodiments, communication network 106 may comprise the Internet, one or more networks that may be public, private, IP-based, non-IP based, and so forth.

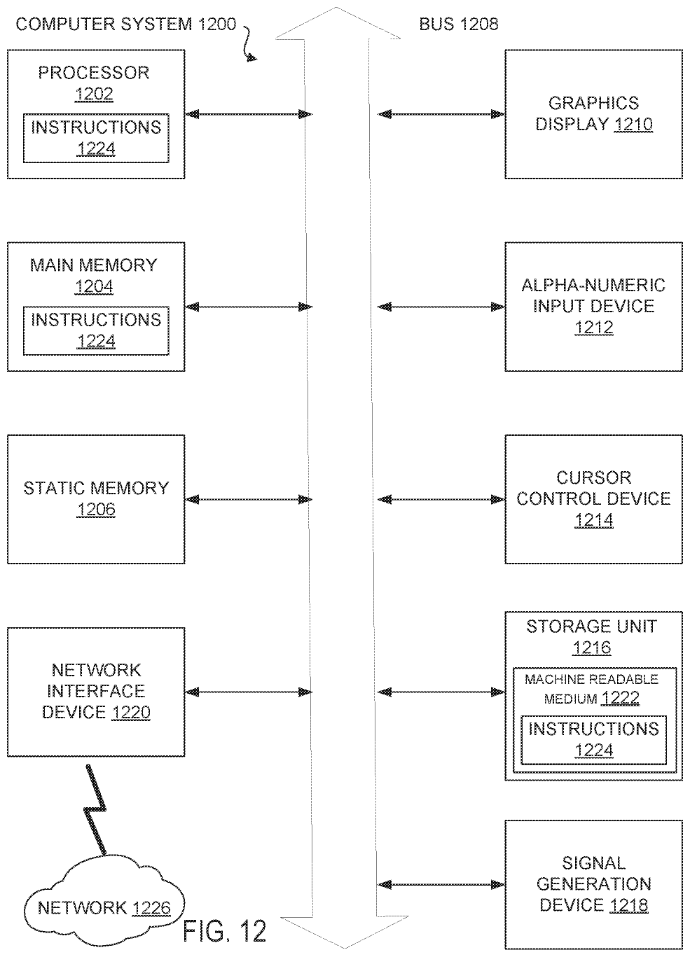

The power system 104 may include any number of digital devices configured to control distribution and/or transmission of energy. The power system 104 may, in one example, be controlled by a power company, utility, and/or the like. A digital device is any device with at least one processor and memory, such as a digital device described in reference to FIG. 12. Examples of systems, environments, and/or configurations that may be suitable for use with the power system 104 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

A computer system may be described in the general context of computer system executable instructions, such as program modules, being executed by a computer system. Generally, program modules may include routines, programs, objects, components, logic, data structures, and so on that perform particular tasks or implement particular abstract data types.

FIG. 1B depicts an example block diagram 150 of an example interaction between the power system 104 of the electrical network 102 and a power system 154 of an energy producer 152, according to some embodiments. FIG. 1B illustrates the power system 104 of the electrical network 102 in communication with the power system 154 of the energy producer 152 over the communication network 106.

The power system 154 may include any number of digital devices configured to control distribution and/or transmission of energy. The energy producer 152 may be an owner of various power generation resources (or units) 156 and may, in one example, be controlled by an electric utility, independent power producer, investor-owned utility, renewable energy developer, energy company, and/or the like. Examples of systems, environments, and/or configurations that may be suitable for use with the power system 154 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The power generation resources 156 may be non-dispatchable (or renewable) resources that generate power (or electricity) (e.g., wind, solar, or a combination thereof), which may be supplied to the electrical network 102. The electricity generated by the power generation resources 156 may be distributed by the electrical network 102, for example, to customers of the electrical network 102 (e.g., residential houses, commercial businesses, and/or the like).

The power system 154 of the energy producer 152 may be configured to provide power generation forecasts (or power forecasts) 160 to the power system 104 of the electrical network 102. A power generation forecast 160 may provide information, such as a prediction of the future electricity output from the power generation resources 156, which is valuable to a grid operator of the electrical network 102 to ensure reliable, efficient, and stable operation of the electrical network 102. For example, the power generation forecasts 160 may help the grid operator plan and manage the balance between electricity supply and demand. As another example, the power generation forecasts 160 can also help with grid operations, such as resource planning. For instance, by knowing in advance how much power the energy producer 152 is expected to produce, the grid operator of the electrical network 102 can optimize the use of available resources.

As a producer with non-dispatchable (or renewable) power generation resources, it may be challenging for the energy producer 152 to accurately determine the power generation forecasts 160, since the electricity output of such non-dispatchable resources is variable, for example, due to changing weather conditions. The need for accurate power generation forecasts 160 is important for the grid operator to reliably incorporate the power generation resources 156 into the electrical network 102 and to determine when and how much renewable energy will be available. To disincentivize inaccurate power generation forecasts 160, the grid operator of the electrical network 102 may impose imbalance penalties 162 on the energy producer 152 when its actual power generation deviates from its forecasted power generation. Accordingly, methods for reducing imbalance penalties are desirable from the viewpoint of owners of non-dispatchable power generation resources.

According to various embodiments described herein, the power system 154 of the energy producer 152 may be configured to apply various approaches for reducing imbalance penalties, especially in the context of non-dispatchable power generation resources.

In some embodiments, the power system 154 may apply a static forecast adjustment (“Approach 1”) to reduce imbalance penalties. Under this approach, power generation forecasts can be statically adjusted by assuming that a grid frequency (or indicator of grid frequency) is more likely to be either below or above its nominal value. In some embodiments, static forecast adjustments under this approach may be achieved by multiplying each baseline power generation forecast by a constant adjustment factor (“Approach 1(a)”). In some embodiments, static forecast adjustments under this approach may be achieved by training a machine learning forecast model against an asymmetric loss function (“Approach 1(b)”).

In various embodiments, the power system 154 may apply a first dynamic forecast adjustment (“Approach 2”) to reduce imbalance penalties. This approach can build upon Approach 1, described above, by adjusting a direction and magnitude of a power generation forecast adjustment based on a forecast of a grid frequency deviation (or an indicator of this deviation) at the time of the power generation forecast. By dynamically adjusting the direction and magnitude, on average, a smaller adjustment of the forecast is required to achieve the same or similar reduction in imbalance penalties as achieved by Approach 1. Furthermore, in contrast to Approach 1, this approach may work even when the grid frequency deviation does not, on average, favor an upward or downward adjustment of the forecast for imbalance penalty reduction.

In other embodiments, the power system 154 may apply a second dynamic forecast adjustment (“Approach 3”) to reduce imbalance penalties. This approach can build upon Approach 2, described above, by adding closed-loop proportional control of the forecast adjustment, so that the average adjustment is made as required to achieve a specified reduction in cumulative imbalance penalties for a given period. Many variations are possible.

To reduce imbalance penalties, the embodiments described herein may require some sacrifice in average accuracy of power generation forecasts. In some embodiments, it will be appreciated that the average accuracy may be sacrificed in systems where penalties are weighted by deviations from nominal grid frequency.

Penalties may be accessed on the energy producer based on overforecasts and underforecasts. While, in various embodiments, the penalties may be consistent regardless of whether there is an overforecast or an underforecast. In some embodiments, the penalties may be inconsistent (e.g., there may be higher penalties for overforecasts relative to underforecasts or vice versa). Further, it may be appreciated that penalties may be weighted differently based on the amount overforecasted relative to the amount underforecasted (e.g., greatly increasing depending on the degree of overforecast or the degree of underforeast). These “asymmetric penalties” may, in some embodiments, impact the forecast adjustment described herein. For example, adjustments to the forecast may be greater or lower depending on the possible asymmetric penalties that may be accessed.

Since power generation forecasts are used in the electricity market clearing process, grid operators (or authorities) desire an accurate forecast and may provide a reference forecast with average accuracy that must be exceeded by any power generation forecast provided by an energy producer (i.e., an owner/operator of a power generation system). Thus, each of the embodiments allow the trade-off between average forecast accuracy and cumulative imbalance penalty reduction to be set so that average forecast accuracy remains consistently above the bound set by the reference forecast. In addition, each of the embodiments may provide the option to compare the accuracy of the adjusted power forecast with the accuracy of a reference forecast and to reduce or stop the adjustments based on this feedback. The embodiments may be applied to forecasts for any non-dispatchable resource, such as wind power, solar power, and combined wind and solar power generation. With these embodiments, a minimal adjustment to the power forecast achieves, on average, a desired reduction in the cumulative imbalance penalty.

Further, according to some embodiments, the power system 154 of the energy producer 152 may be configured to reduce imbalance penalties without having to adjust power generation forecasts by instead optimally controlling the charging and discharging of a battery energy storage system (BESS) 158 associated with the power generation resources 156 to reduce or eliminate imbalance penalties. For example, in various embodiments, the power system 154 may charge and discharge the BESS 158 based on a forecast of grid frequency deviation and an adjustment factor, for example, as described in reference to Approaches 2 and 3, and stop using the BESS 158 when the running cumulative imbalance penalty significantly exceeds a desired value. Additional details describing the various embodiments are provided below.

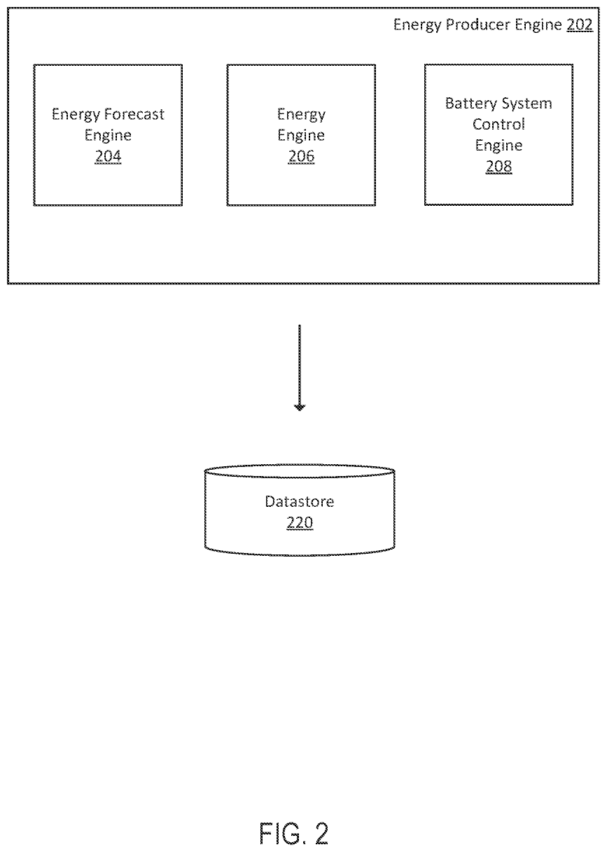

FIG. 2 depicts a block diagram of an example energy producer engine 202 according to some embodiments. The energy producer engine 202 may be implemented in a computer system that includes at least one processor, memory, and communication interface. For example, the energy producer engine 202 may be implemented in the power system 154 of the energy producer 152, as described in reference to FIG. 1B. The computer system can execute software that performs any number of functions described in relation to FIGS. 2-10.

The energy producer engine 202 includes an energy forecast engine 204, an energy imbalance engine 206, and an optional battery system control engine 208. The energy producer engine 202 can access a datastore 220, for example, to access various energy data, historical data, and/or frequency data.

The energy forecast engine 204 may be configured to determine or obtain power generation forecasts associated with a given energy producer. For example, the energy producer may produce electricity for an electrical network based on various renewable (or non-dispatchable) power generation resources, such as solar and wind energy.

The energy forecast engine 204 may determine such power generation forecasts using a combination of meteorological data, historical performance data, and advanced forecasting techniques. These forecasts are essential for grid operators and energy market participants associated with electrical networks to plan for and integrate the variable nature of these energy sources. For example, meteorological data may include information on solar radiation, wind speed, temperature, and cloud cover as collected from various sources, such as weather stations, satellites, and weather models. Further, historical performance data may provide information describing historical energy production from power generation resources, which may help calibrate forecast models.

The energy forecast engine 204 may apply various forecasting models and techniques either alone or in combination to determine power generation forecasts. For example, the energy forecast engine 204 may apply numerical weather prediction models, which may simulate atmospheric conditions and provide weather forecasts, to estimate solar and wind conditions. In another example, the energy forecast engine 204 may apply statistical models to analyze historical data to identify patterns and correlations between weather variables and energy generation. These models can include autoregressive integrated moving average (ARIMA) models and regression analysis. In yet another example, the energy forecast engine 204 may apply advanced machine learning algorithms, such as neural networks and ensemble methods, which may be trained on historical data to improve the accuracy of power generation forecasts.

When determining power generation forecasts, the energy forecast engine 204 may consider site-specific factors, such as the characteristics of the renewable energy installation (e.g., panel efficiency for solar, turbine type for wind), location-specific factors (e.g., elevation, shading, terrain), and/or historical generation data for that site. Further, the energy forecast engine 204 may determine power generation forecasts at various temporal and spatial resolutions. For example, short-term forecasts may provide hourly or sub-hourly predictions, while long-term forecasts may extend over weeks or months. Moreover, spatial resolutions can range from single sites to larger regions. In some instances, the energy forecast engine 204 may provide measurements of uncertainty associated with power generation forecasts. Such measurements may help grid operators and market participants make informed decisions in the presence of variability and uncertainty.

The energy forecast engine 204 may continuously update and refine forecast models based on new data and improved modeling techniques. Further, feedback from actual power generation may be used to improve the accuracy of future power generation forecasts.

In various embodiments, the energy forecast engine 204 may adjust power generation forecasts based on various approaches for reducing energy imbalance penalties.

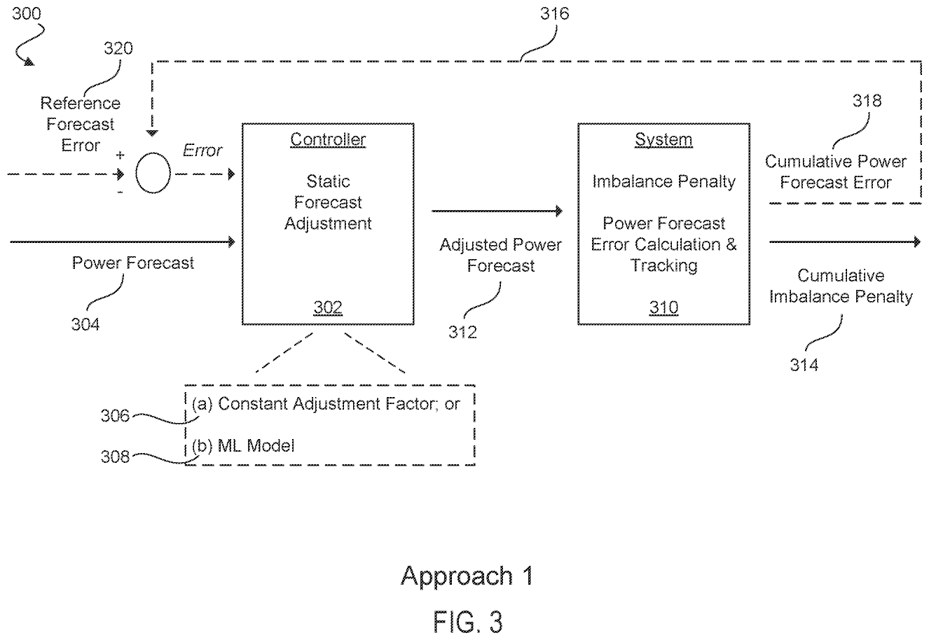

In some embodiments, the energy forecast engine 204 may apply a static forecast adjustment 300 (“Approach 1”) to reduce imbalance penalties, as illustrated in the example of FIG. 3. Under this approach, an operation to adjust a power generation forecast remains static during a reconciliation period for an imbalance penalty. For example, power generation forecasts can be statically adjusted by assuming that a grid frequency (or indicator of grid frequency) is more likely to be either below or above its nominal value. In this example, an assumption may be made that a grid frequency of an electrical network is more often below, rather than above, its nominal value, which indicates that the electrical network requires more power generation. In this example, consistently under-forecasting power generation may help reduce imbalance penalties. In another example, an assumption may be made that a grid frequency of an electrical network is more often above, rather than below, its nominal value, which indicates that the electrical network requires less power generation. In this example, consistently over-forecasting power generation helps reduce imbalance penalties.

In the example of FIG. 3, the energy forecast engine 204 may be implemented as a controller 302 that applies static forecast adjustments to power generation forecasts 304 according to a constant adjustment approach 306 or a machine learning approach 308.

In the constant adjustment approach 306, the energy forecast engine 204 may apply static forecast adjustments by multiplying each power generation forecast 304 by a constant adjustment factor (“Approach 1(a)”). For example, if the assumption is that a grid frequency of an electrical network is more often below its nominal value, then the controller 302 may multiply each baseline power forecast 304 by a constant adjustment factor on the order of, but slightly less than 1. In contrast, if the assumption is that a grid frequency of an electrical network is more often above its nominal value, then the controller 302 may multiply each baseline power generation forecast 304 by a constant adjustment factor on the order of, but slightly greater than 1.

In the machine learning approach 308, the controller 302 may apply static forecast adjustments by training a machine learning forecast model against an asymmetric loss function (“Approach 1(b)”). For example, if the assumption is that a grid frequency of an electrical network is more often below its nominal value, then the controller 302 may train the machine learning forecast model so that the distribution of forecast errors favors an under-forecast. Similarly, if the assumption is that a grid frequency of an electrical network is more often above its nominal value, then the controller 302 may train the machine learning forecast model so that the distribution of forecast errors favors an over-forecast.

The energy imbalance determination engine 206 may be configured to determine imbalance penalty assessments for power generation forecasts determined by the energy forecast engine 204. For instance, in reference to FIG. 3, the energy imbalance determination engine 206 may be implemented as a system 310 that determines imbalance penalty assessments for adjusted power generation forecasts 312. The system 310 may determine a cumulative imbalance penalty 314 for a given adjusted power generation forecast 312. The cumulative imbalance penalty 314 may provide a numerical cost that may be assessed to an energy producer for a power generation forecast corresponding to a given period. In general, the formulas and methods for calculating imbalance penalties in electricity markets may be defined by regulatory authorities, grid operators, and/or market administrators responsible for managing an energy market. These formulas and methods are often documented in market rules, tariffs, and operating procedures of the relevant jurisdiction or market. The energy forecast engine 204 (and the system 310) may implement such formulas and methods to compute the imbalance penalty assessments in any given jurisdiction and/or market.

In some embodiments, an additional mechanism may optionally be implemented to ensure that adjustments to power generation forecasts under the static forecast adjustment 300 do not reduce average forecast accuracy below that of a reference standard. In such embodiments, the system 310 may be configured to determine and track power generation forecast errors. As shown in FIG. 3, a feedback loop 316 provides an option to monitor and compare a cumulative error of a power generation forecast 318 against a cumulative error of a reference forecast 320. In such embodiments, if adjustments 312 to power generation forecasts consistently reduce average forecast accuracy below that of the reference forecast 320, the controller 302 may reduce or halt adjustments to power generation forecasts.

In other embodiments, the energy forecast engine 204 may apply dynamic forecast adjustments to reduce imbalance penalties (or potential imbalance penalties).

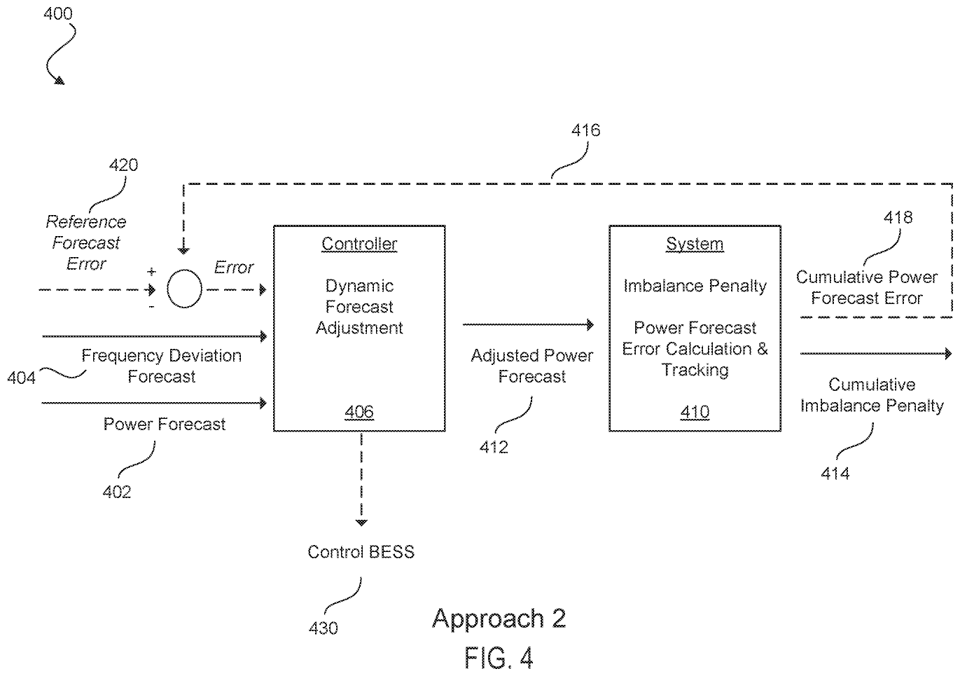

For example, in some embodiments, the energy forecast engine 204 may apply a first dynamic forecast adjustment 400 (“Approach 2”) to reduce imbalance penalties, as illustrated in the example of FIG. 4. This approach may build upon the static forecast adjustment 300, as described in reference to FIG. 3, by adjusting a direction and magnitude of an adjusted power generation forecast. Under this approach, an operation to adjust a power generation forecast may vary with each forecast throughout a reconciliation period depending on a forecast of deviation from a nominal grid frequency.

For example, the energy forecast engine 204 may be implemented as a controller 406. The controller 406 may obtain a power generation forecast 402 and a forecast (or an indicator) of a grid frequency deviation 404. The power generation forecast 402 may correspond to an adjusted power generation forecast, for example, as determined based on the static forecast adjustment 300. The controller 406 may dynamically adjust a direction and magnitude of the power generation forecast 402 based on the forecast (or indicator) of the grid frequency deviation 404 at the time of the power generation forecast 402. By dynamically adjusting the direction and magnitude, on average, a smaller adjustment to the power generation forecast 402 may be required to achieve the same or similar cumulative reduction in imbalance penalties as achieved by the static forecast adjustment 300. Furthermore, in contrast to the static forecast adjustment 300, the first dynamic forecast adjustment may work even when the grid frequency deviation 404 does not, on average, favor an upward or downward adjustment of the forecast for imbalance penalty reduction.

The forecast of the grid frequency deviation 404 may be determined or obtained. For example, the energy forecast engine 204 may determine the forecast of the grid frequency deviation 404 by predicting how an electrical grid's operating frequency will vary over time. Such predictions may involve analysis of historical frequency data to determine patterns, trends, and seasonality in frequency variations, real-time monitoring using high-precision instruments (e.g., phasor measurement units (PMUs)), analysis of weather and load forecasts, numerical weather prediction models, statistical models, advanced machine learning algorithms, and/or load-frequency control models, to name some examples. In some instances, rather than forecasting, the energy forecast engine 204 may obtain an indicator of a grid frequency deviation (e.g., a frequency indicator (FI)) for an electrical network, which may be published by a grid operator of the electrical network.

In the example 400 of FIG. 4, the energy imbalance engine 206 may be implemented as a system 410. The system 410 may be configured to determine imbalance penalty assessments for power generation forecasts adjusted by the controller 406. The system 410 may determine a cumulative imbalance penalty 414 for a given adjusted power generation forecast 412. The cumulative imbalance penalty 314 may provide a numerical cost that may be assessed to an energy producer for a power generation forecast corresponding to a given period.

In some embodiments, an additional mechanism may optionally be implemented to ensure that adjustments to power generation forecasts under the first dynamic forecast adjustment do not reduce average forecast accuracy below that of a reference standard. In such embodiments, the system 410 may be configured to determine and track power generation forecast errors. As shown in FIG. 4, a feedback loop 416 provides an option to monitor and compare a cumulative error of a power generation forecast 418 against a cumulative error of a reference forecast 420. In such embodiments, if adjustments 412 to power generation forecasts consistently reduce average forecast accuracy below that of the reference forecast 420, the controller 406 may reduce or halt adjustments to power generation forecasts.

The battery system control engine 208 may be configured to reduce imbalance penalties without having to adjust power generation forecasts under the first dynamic forecast adjustment by instead optimally controlling 430 the charging and discharging of a battery energy storage system (BESS) associated with an energy producer that provides the power generation forecasts 502. For example, the battery system control engine 208 may charge and discharge the BESS based on a forecast of grid frequency deviation 404 and an adjustment factor.

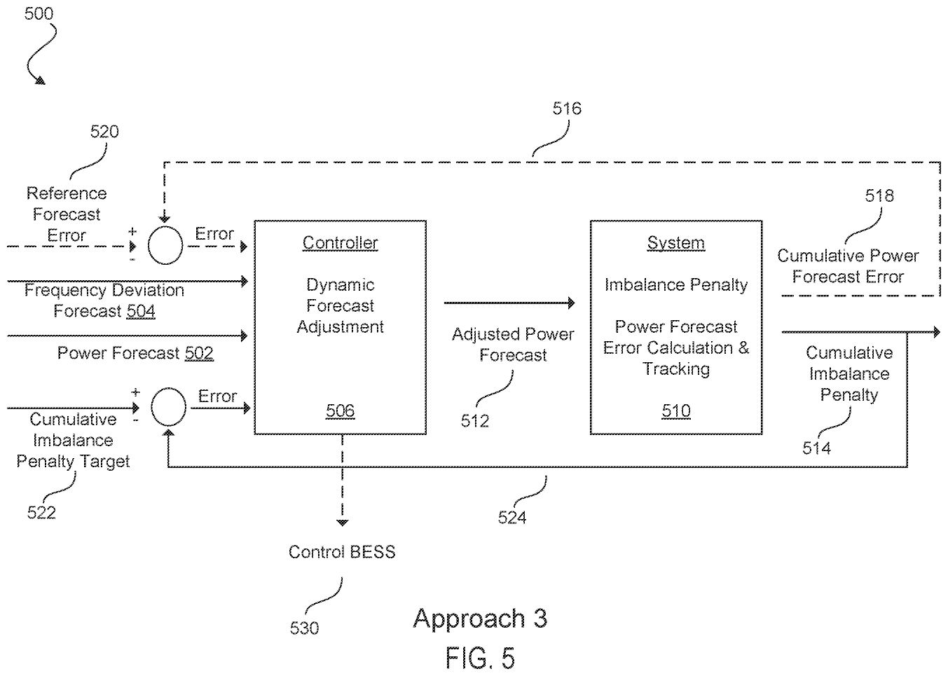

In some embodiments, the energy forecast engine 204 may apply a second dynamic forecast adjustment 500 (“Approach 3”) to reduce imbalance penalties, as illustrated in the example of FIG. 5. This approach may build upon the static forecast adjustment 300 and the first dynamic forecast adjustment, as described in reference to FIGS. 3 and 4, by adding a closed-loop proportional control of a power generation forecast adjustment, so that an average adjustment is made as needed to achieve a specified reduction in cumulative energy imbalance costs for a given period.

For example, the energy forecast engine 204 may be implemented as a controller 506. The controller 406 may be configured to obtain a power generation forecast 502 and a forecast (or an indicator) of a grid frequency deviation 504. The power generation forecast 502 may correspond to an adjusted power generation forecast, as determined based on the static forecast adjustment 300, as described in reference to FIG. 3. The controller 506 may dynamically adjust a direction and magnitude of the power generation forecast 502 based on the forecast (or indicator) of the grid frequency deviation 504 at the time of the power generation forecast 502.

In the example of FIG. 5, the energy imbalance engine 206 may be implemented as a system 510. The system 510 may be configured to determine imbalance penalty assessments for power generation forecasts adjusted by the controller 506. The system 510 may determine a cumulative imbalance penalty 514 for a given adjusted power generation forecast 512. The cumulative imbalance penalty 514 may provide a numerical cost that may be assessed to an energy producer for a power generation forecast corresponding to a given period.

The system 510 may be configured to determine an error based on a comparison of a reference (or target) cumulative imbalance penalty 522 and the cumulative imbalance penalty 512 via a closed-loop proportional control 524. The controller 506 may continuously vary adjustments to each power generation forecast 502 based on the error in order to achieve the cumulative imbalance penalty target 522. Under this approach, the cumulative imbalance penalty at the end of a reconciliation period will be close to the target cumulative imbalance penalty 522.

In some embodiments, an additional mechanism may optionally be implemented to ensure that adjustments to power generation forecasts under the second dynamic forecast adjustment 500 do not reduce average forecast accuracy below that of a reference standard. In such embodiments, the system 510 may be configured to determine and track power generation forecast errors. As shown in FIG. 5, a feedback loop 516 provides an option to monitor and compare a cumulative error of a power generation forecast 518 against a cumulative error of a reference forecast 520. In such embodiments, if adjustments 512 to power generation forecasts consistently reduce average forecast accuracy below that of the reference forecast 520, the controller 506 may reduce or halt adjustments to power generation forecasts.

The battery system control engine 208 may be configured to reduce imbalance penalties without having to adjust power generation forecasts under the second dynamic forecast adjustment 500 by instead optimally controlling 530 the charging and discharging of a battery energy storage system (BESS) associated with an energy producer that provides the power generation forecasts 502. For example, the battery system control engine 208 may charge and discharge the BESS based on a forecast of grid frequency deviation 504 and an adjustment factor. Further, under the second dynamic forecast adjustment 500, the battery system control engine 208 may stop using the BESS when the running cumulative imbalance penalty 514 significantly exceeds the cumulative imbalance penalty target 522.

### Techniques for Managing Imbalance Penalties Based on Causer Pays Factor (CPF)

Below are details of specific implementations for electricity markets that calculate imbalance penalties based on a Causer Pays Factor (CPF) approach, such as the Australian Energy Market governed by the Australian Energy Market Operator (AEMO). In general, AEMO monitors grid frequency and publishes a Frequency Indicator (FI), an indicator of deviation from nominal grid frequency. Furthermore, AEMO may provide a reference forecast, such as the Australian Wind Energy Forecasting System (AWEFS) forecast. In various embodiments, the imbalance penalty mitigation techniques described in reference to FIGS. 3-5 may be specialized for the Australian Energy Market by substituting “CPF” for “Imbalance Penalty”, “FI Forecast” for “Frequency Deviation Forecast”, and “AWEFS Forecast Error” for “Reference Forecast Error”. Additional background and details related to such adaptation are provided below.

As background, AEMO may calculate energy imbalance penalties based on Causer Pays Factor (CPF) measurements in relation to some reconciliation period. For example, the Causer Pays Factor (CPF) measurement may be determined for a 28-day period, which is determined from the following formula:

$$Resultantfactor = f ( LEF , LNEF , REF , RNEF ) = min ( 0 , RNEF + LNEF ) + min ( 0 , LEF ) + min ( 0 , REF ) ,$$

where RNEF is the raise non-enabled factor and LNEF is the lower non-enabled factor. Thus, RNEF considers the deviations when the system needs Raise Reserve, while LNEF considers the deviations when the system needs Lower Reserve. This equation shows that accumulating a RNEF and LNEF total above zero brings little to no benefit to energy producers (or generation system owners). Lower enabled factor (LEF) and raise enabled factor (REF) are not applicable to wind and solar generation systems and are considered zero. Given this, the above equation can be simplified to:

$$CPF ( total ) = min ( 0 , RNEF + LNEF ) .$$

The values for RNEF and LNEF are calculated as follows:

Deviation=Actual(production)−Forecast(used as target).

Frequency Indicator (FI) is a parameter from AEMO's automatic generation control that indicates how much more or less generation capacity is required to adjust the frequency towards 50 Hz. FI can also be calculated by summing the GenRegComp_MW (as defined by Australian Energy Market Operator) values in the area. The upper and lower limits of the FI are capped at +/−1560. The sign of FI indicates the direction of regulating capability required at a given time (positive for a regulating raise service, negative for a regulating lower service).

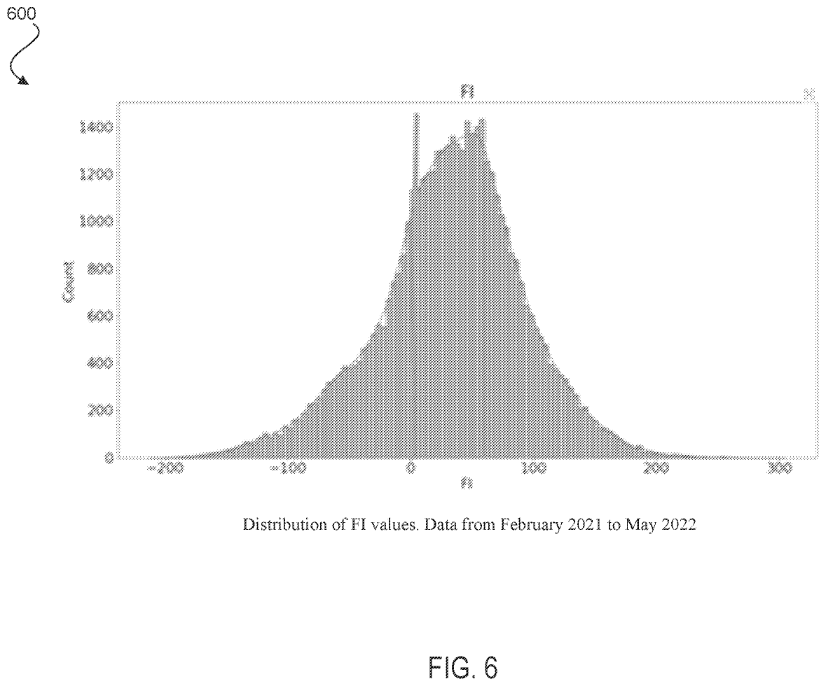

An analysis of FI historical values shows that its distribution is heavily skewed towards positive values, as illustrated in the example 600 of FIG. 6. For instance, when the frequency is below 50 Hz, the system needs Raise Reserve (more generation to increase frequency), and FI values become positive. In these cases, an under-forecast is helping the system because an energy producer (e.g., a wind farm) is delivering more power than anticipated, helping the system to raise the frequency. This is the most frequent case as per the distribution of FI shown in FIG. 6. In contrast, when the frequency is above 50 Hz, the system needs Low Reserve (less generation to decrease frequency), and FI values become negative. In these cases, an over-forecast is also helping the system because the wind farm is delivering less power than anticipated, helping the system to lower the frequency. For any other combination, the wind farm will become a causer of system imbalance, as opposed to a helper, and CPF factors will arise consequently. The following table helps illustrate relationships between FI values and forecasts, and how such relationships may be used to classify an energy producer as a “helper” or a “causer”:

TABLE 1
Classification as Helper or Causer Based on FI and Forecast

| | Under | Over |
|---|---|---|
| | Forecast | Forecast |
| FI Positive | HELPER | CAUSER |
| (Grid frequency < 50 Hz) | | |
| FI Negative | CAUSER | HELPER |
| (Grid frequency > 50 Hz) | | |

To maintain the integrity of the system and receive the best quality forecasts possible from each self-forecast (SF) provider, AEMO will assess the ongoing performance on a weekly basis, which may be based on rolling one, four, and eight full-week assessment windows. AEMO may assess the ongoing performance of the provided forecasts to verify that the self-forecast is no worse than a reference forecast, as determined by AEMO's own forecasting system, over at least one of the assessment windows.

The short assessment window (e.g., one week) may allow the SF performance to reflect more recent, potentially large SF model improvements, while the medium and long assessment windows (e.g., four and eight weeks) capture the impact on SF performance of a greater diversity of weather conditions and reduce the risk that SF is not assessed for constrained generating units.

In sum, for a self-forecast to still be eligible to be used in dispatch, it needs to be at least as accurate as the AWEFS forecast (i.e., the forecast produced by AEMO itself), in terms of both Mean Absolute Error (MAE)—Equation (1)—and Root Mean Squared Error (RMSE)—Equation (2)—in at least one of the time windows (e.g., one week, four weeks, or eight weeks).

$${MAE}_{SF} \leq {MAE}_{AWEFS} \qquad ( Equation 1 )$$

$$RMS {E}_{SF} \leq RMS {E}_{AWEFS} \qquad ( Equation 2 )$$

The accuracy of both forecasts (SF and AWEFS) is measured against an Actual Value (representing the “ground truth”) that, depending on the mode of operation (non-curtailment or curtailment) corresponds to the actual power generated or the potentially available power.

For this reason, each of the three approaches described herein to reduce CPFs allows the trade-off between cumulative CPF reduction and average power forecast accuracy to be adjusted to reduce the risk of disqualification to a desired negligible level. Furthermore, the approaches described in reference to FIG. 3-5 may be adapted for use with AEMO. For example, the difference in accuracy between the energy producer's forecast and AEMO's reference forecast can be monitored and tracked by a system and the result fed back to a controller. Duplicating the steps in AEMO's ongoing assessment process, the controller can reduce or stop the adjustment of the power forecast if the producer's forecast error is likely to lead to suppression of the producer's forecast. No matter how accurate the producer's forecast, there is always some possibility that a change in grid conditions or period of unfavorable weather conditions will degrade the relative accuracy of the producer's forecast and increase the likelihood of suppression. An optional feedback loop helps ensure that power forecast adjustment for reduced CPF does not significantly contribute to a reduction in average forecast accuracy below the standard set by AEMO.

In various embodiments, the energy producer engine 202 of FIG. 2 may be configured to manage imbalance penalties in electricity markets that rely on CPF, such as the Australian energy market.

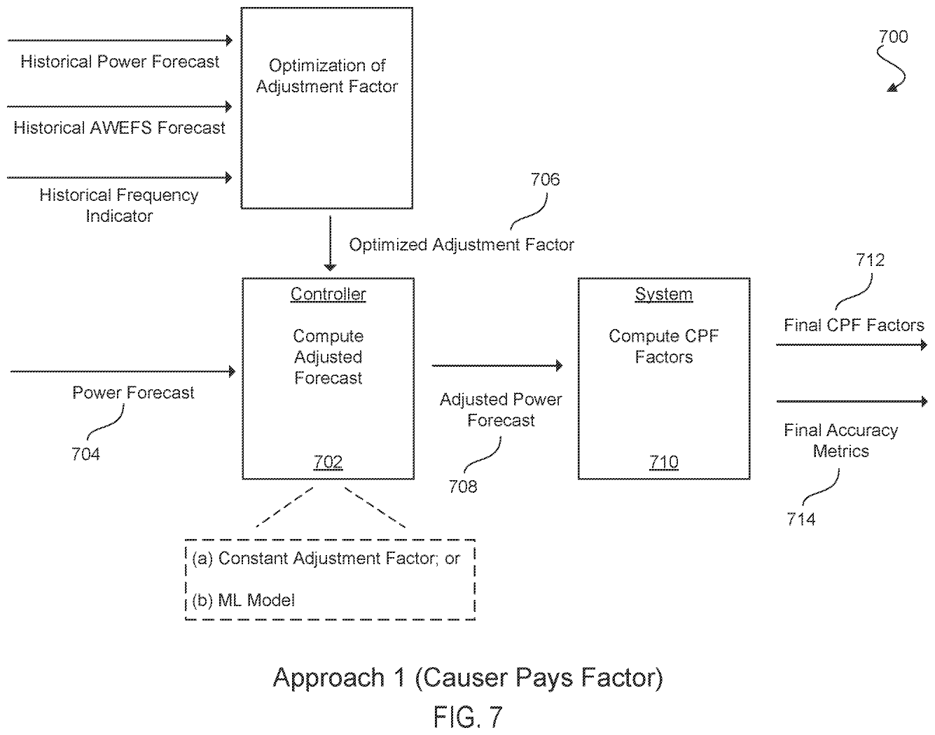

For example, in some embodiments, the static forecast adjustment 300 of FIG. 3 may be adapted to determine adjusted forecasts and CPF factors, as illustrated in the example 700 of FIG. 7. For example, the energy forecast engine 204 may be implemented as a controller 702 which, for each forecast period, multiplies an unadjusted power generation forecast 704 by a single adjustment factor 706 that will, on average, result in a reduction in the CPF. Hence, the adjusted power generation forecast 708 provided by the controller 702 is:

$${F}_{Adjusted} = Power Forecast \times {A}_{Factor} .$$

where F_{Adjusted} is the adjusted power generation forecast, Power Forecast is the unadjusted power generation forecast provided by an energy producer, and where A_{Factor} is the single adjustment factor.

The adjustment factor 706 may be chosen to minimize CPF factors without unduly compromising the forecast accuracy. The controller 702 may optimize the adjustment factor 706 based on observed frequency deviations in previous historical periods. A historical period can be defined as: 1) a longer period that captures longer-term trends of the frequency deviation, as measured by a Frequency Indicator (FI); or 2) a shorter period that captures more short-term trends of the frequency deviation, as measured by the FI.

The controller 702 may define the final adjustment factor for the next (or the next k) reconciliation periods by evaluating the trade-off between CPF reduction and the risk of disqualification. A range of potential adjustment factors can be evaluated including, for example 0.95, 0.96, 0.97, 0.98, and 0.99. When tested against historical data from the Australian National Energy Market, such small adjustments to the power forecast 704 may significantly reduce or eliminate CPF costs.

The energy imbalance determination engine 206 may be implemented as a system 710, as shown in FIG. 7. The system 710 may compute CPF factors (or imbalance penalties) 712 and accuracy metrics 714 (e.g., a cumulative power forecast error) based on the adjusted power generation forecast 708.

In various embodiments, rather than post-processing the power forecast 704 by applying an adjustment factor 706 a posteriori, the controller 702 may generate the power forecast 704 from a machine learning forecast model that has been trained with an asymmetric loss function.

Currently, many forecasting systems use mean average error (MAE) as a loss function. Using this function, the machine learning model is trained to minimize the MAE of the forecast, regardless of whether the errors are negative (under-forecasting) or positive (over-forecasting). However, given the likelihood of long-term variations of the grid frequency (for example, seasonal variation in demand, installation of new generation capacity, etc.), over-forecasts can have a more negative effect on CPF at the end of the reconciliation period than under-forecasts, and vice-versa. In some embodiments, the forecast model may be modified to reduce CPFs by training the model with an asymmetric loss function. This allows assignment of a higher penalty to over-forecasts or under-forecasts, depending on the grid frequency deviation trends during a previous historical period (a training period). This is achieved by adding a penalty coefficient to the predictions that should be penalized more. Below is an example of an asymmetric loss function, which may be implemented by the controller 702, that penalizes over-forecasts more than under-forecasts:

$$Loss = \{ \begin{matrix}abs ( {y}_{true} - {y}_{pred} ) , & if y\_true >= y\_pred \\ C \cdot abs ( {y}_{true} - {y}_{pred} ) , & if y\_true < y\_pred , C > 1\end{matrix} .$$

The penalty coefficient (as well as which errors to penalize more) can be optimized following the same principles used for the single adjustment factor 706, as described above.

In some embodiments, a control on the forecast accuracy may be implemented, e.g., the feedback loop 316 shown in FIG. 3. This control would measure forecast accuracy following AEMO methodology and would stop the submission of the adjusted forecast in case forecast accuracy degrades to the point of imminent suppression (disqualification). In that case, the default unadjusted forecast would be submitted to AEMO.

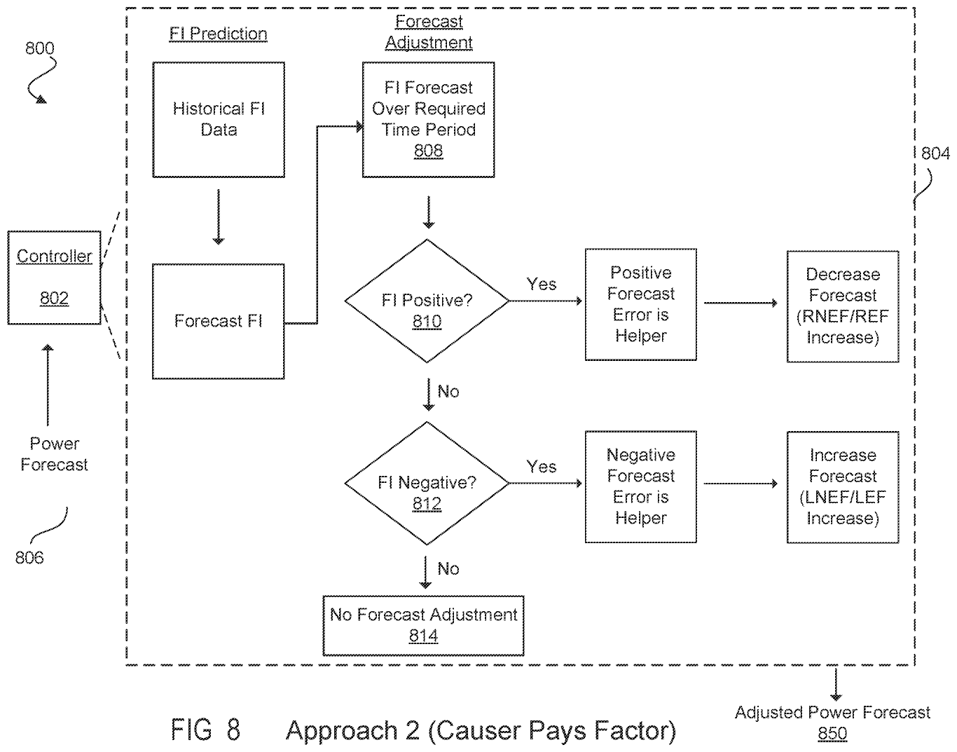

In various embodiments, the dynamic forecast adjustment of FIG. 4 may be adapted to dynamically determine adjusted forecasts and CPF, as illustrated in the example 800 of FIG. 8. For example, the energy forecast engine 204 may be implemented as a controller 802 that performs operations illustrated in the example 800 of FIG. 8. The controller 802 may receive inputs and provide outputs like the controller 406 of FIG. 4. The outputs 850 from the controller 802 may be processed by a system, such as the system 410 of FIG. 4.

According to the discussion of AEMO's Frequency Control Ancillary Services Market above, to increase the probability that an energy producer is a helper for frequency regulation, power generation forecasts should be adjusted down when a frequency indicator (FI) is positive and adjusted up when the FI is negative. Under this dynamic approach, a forecast of FI is used to determine adjustments to power generation forecasts for each forecast period. This dynamic adjustment increases the probability that the energy producer is a helper for frequency regulation. In contrast to static forecast adjustments, as described in reference to FIG. 7, this dynamic approach achieves a targeted reduction in cumulative CPF with a smaller average adjustment of a power generation forecast and thus a smaller average reduction in forecast accuracy.

The factors for downward and upward adjustment of the power forecast are optimized with the same considerations as described for the static approach discussed in reference to FIG. 7. The magnitudes of the upward and downward adjustment factors can vary. However, upward adjustments tend to be more beneficial than downward adjustments, so the magnitude of the upward adjustment factor can be very close to 1 (e.g., 1.01, 1.02, 1.03) or equal to 1 (that is, no adjustment).

FIG. 8 shows an example flow diagram 804 of a demonstrated method for dynamically adjusting a power generation forecast 806 based on a forecast of FI. First, the controller 802 may generate FI forecasts (or predictions) 808 for a test (or required) period. The FI forecasts 808 may be generated based on historical FI data. The controller 802 may forecast FI using a moving-average, an autoregressive integrated moving average, or machine learning. In some embodiments, a 30-minute moving-average is used for forecasting FI in the Australian Energy market, which may require less computational resources.

Based on the polarity of the FI forecast, the controller 802 may adjust the power generation forecast 806 either upward or downward. If the FI forecast is positive 810, then a system operator (e.g., AEMO) wants the generation to go up, which means a positive forecast error (computed as actual-forecast) is a helper, not a causer. Accordingly, the controller 802 may decrease the power generation forecast 806, which means a raise non-enabled factor (RNEF) and/or a raise enabled factor (REF) will increase.

If the FI forecast is negative 812, then the system operator wants the generation to go down, which means a negative forecast error (computed as actual-forecast) is a helper, not a causer. Accordingly, the controller 802 may increase the power generation forecast 806, which means a lower non-enabled factor (LNEF) and/or a lower enabled factor (LEF) will increase. The controller 802 may apply an adjustable threshold 814 as a confidence level for the FI forecast, below which, the power generation forecast 806 is not adjusted.

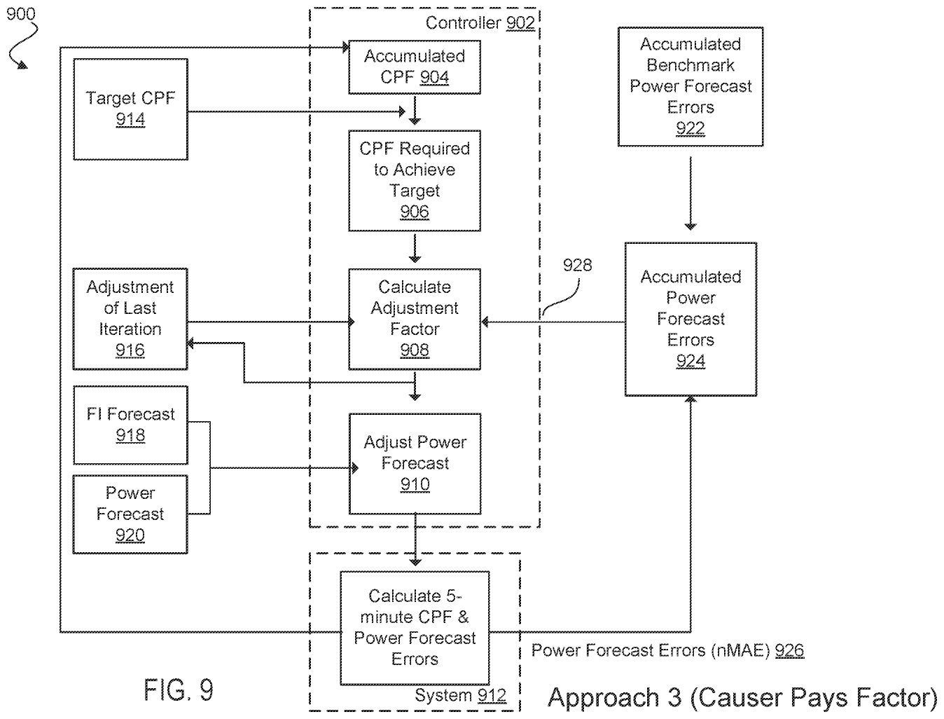

In various embodiments, the dynamic forecast adjustment 500 of FIG. 5 may be adapted to dynamically determine adjusted forecasts and CPF, as illustrated in the example 900 of FIG. 9. For example, the energy forecast engine 204 may be implemented as a controller 902 and the imbalance penalty determination engine 206 may be implemented as a system 912.

In some cases, different months may require different adjustment values to achieve zero cumulative CPF. However, it is difficult to know the exact adjustment factor to use for each month because of the uncertain nature of this problem. For example, if an adjustment factor that gets every month to either zero cumulative CPF or close to it is used, then the CPF of some months may end up at a much greater value. Accumulating a CPF greater than 0 for a month does not bring any revenue to energy producers and in addition, it may significantly degrade the forecast accuracy. Therefore, it is desirable to have a solution where the required adjustment factor used for each month either achieves zero CPF or a target value, which can be either positive or negative.

The approach illustrated in FIG. 9 applies a closed-loop proportional controller 902 that dynamically varies an adjustment factor (e.g., for forecast adjustment) 910 throughout a 28-day reconciliation period based on accumulated CPF values 904 over the period.

The controller 902 may calculate an adjustment factor 908 based on the accumulated CPF values 904 and a CPF value 906 required to achieve a target CPF value 914. For example, the controller 902 may increase the adjustment factor 908 (decreases the value) if the accumulated CPF value 904 is lower than the target CPF value 914 and may decrease the adjustment factor 908 (increases the value) if the accumulated CPF value 904 is above the target CPF value 914. The rate at which the controller 902 may increase and decrease the adjustment factor 910 is based on the difference between the accumulated CPF value 904 and the target CPF value 914. Similarly, the closed-loop approach 900 can also keep track of the forecast accuracy and stop adjusting the forecast if its accuracy drops below a set threshold.

Under the approach 900, the parameters that may be set are as follows:

1. Lower and upper limits of the adjustment factor 908. The starting value of the adjustment factor 908 can be any value in between these lower and upper limit values. Setting these limits determines the trade-off between cumulative CPF reduction and average power forecast accuracy. The settings are tested against historical data, as described for Approach 1 above, to determine the optimum trade-off for the intended purpose.

2. Target CPF 914. As an example, if it is desired to achieve zero cumulative CPF, this target may be set slightly above 0 to reduce the probability of completing the month with a negative CPF.

3. Gain of the proportional controller: This is a slope that increases or decreases the adjustment factor based on the required CPF needed to achieve the target CPF value.

4. The margins by which power forecast errors (MAE and RMSE) 926 must be less than the corresponding forecast errors of a grid operator's reference (or benchmark) forecast. These margins are set points for a feedback loop 928 in which accumulated power forecast errors 924 and accumulated benchmark forecast errors 922 are fed to the calculation of the adjustment factor 908. This feedback loop 928 allows the adjustment of the power forecast to be reduced or stopped when the average accuracy does not exceed that of a reference forecast by the set margins.

The closed-loop proportional controller 902 may use a FI forecast to determine if the power forecast is adjusted or not (as in Approach 2). In some embodiments, the proportional control loop can be implemented without the FI forecast, but its absence may, on average, mean larger power forecast adjustments (greater loss of average power forecast accuracy) for a given cumulative CPF reduction.

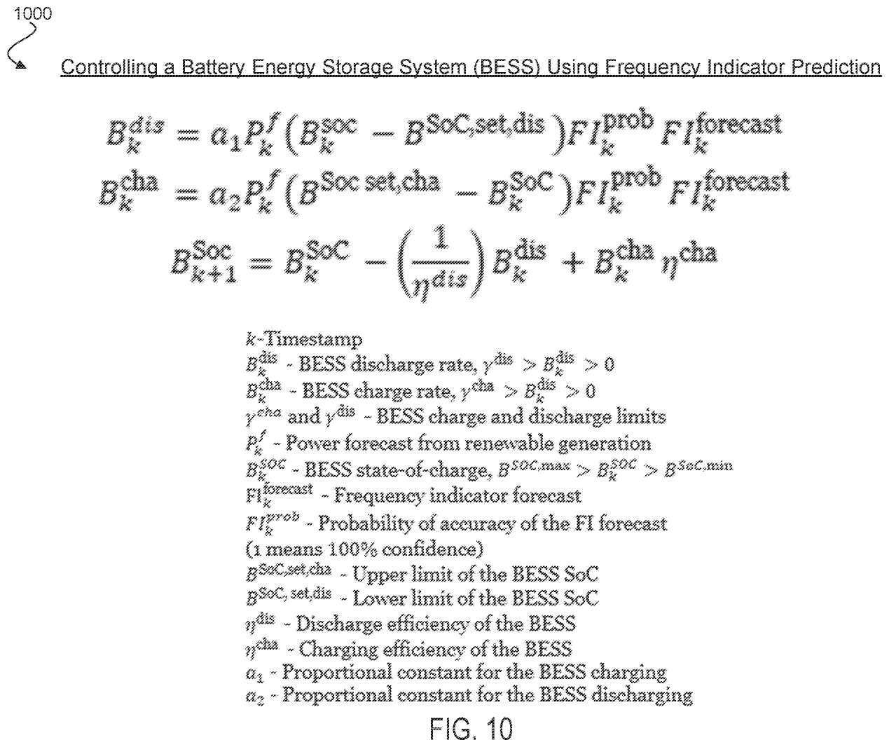

In some embodiments, the battery system control engine 208 may be configured to reduce imbalance penalties without having to adjust power generation forecasts. That is, the battery system control engine 208 may charge and discharge a battery energy storage system (BESS) based on a FI forecast and an adjustment factor, as determined under approach 800 of FIG. 8. Further, the battery system control engine 208 may stop using the BESS when a running CPF value significantly exceeds a desired CPF value based on some threshold, as determined under approach 900 of FIG. 9. By controlling the BESS as such, the battery system control engine 208 may achieve fewer BESS cycles for a given cumulative CPF reduction. Further, the battery system control engine 208 may help AEMO plan their frequency control ancillary services (FCAS) market by providing a charge/discharge schedule (e.g., for 5-minute intervals determined every 30 minutes) to AEMO. This approach for controlling the BESS may work optimally when energy resources (e.g., a wind farm) and a BESS are considered as two different entities, but CPF accumulation from the BESS may be still used to offset a negative CPF from the energy resources (e.g., the wind farm). In various embodiments, the battery system control engine 208 may control a BESS using FI prediction in accordance with the equations 1000 provided in FIG. 10.

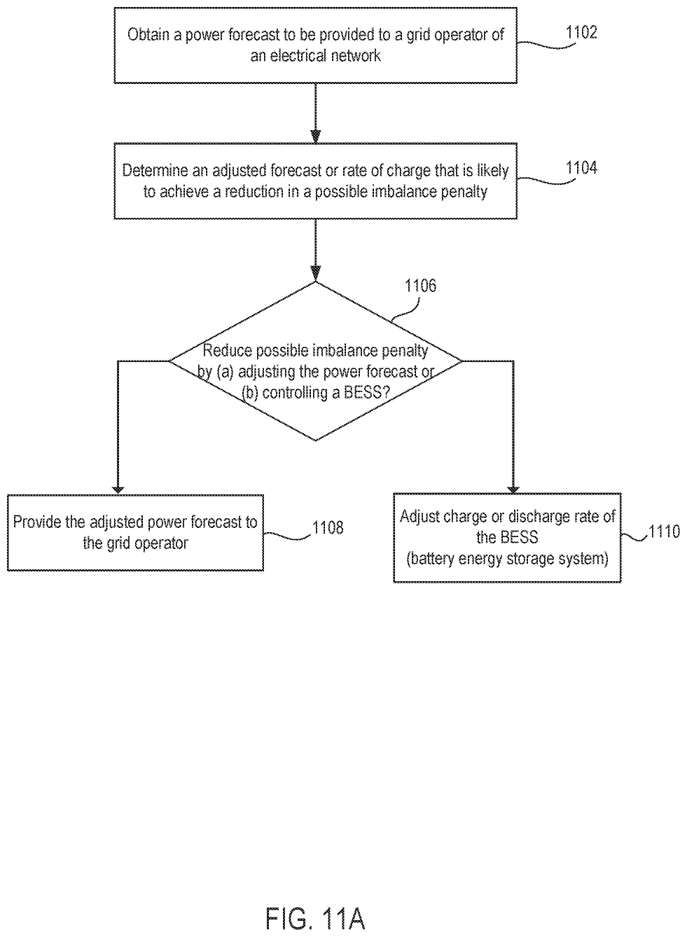

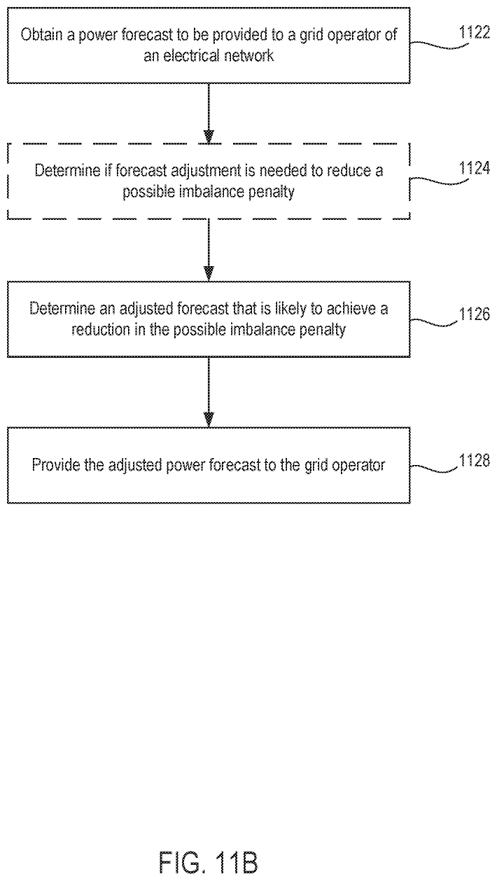

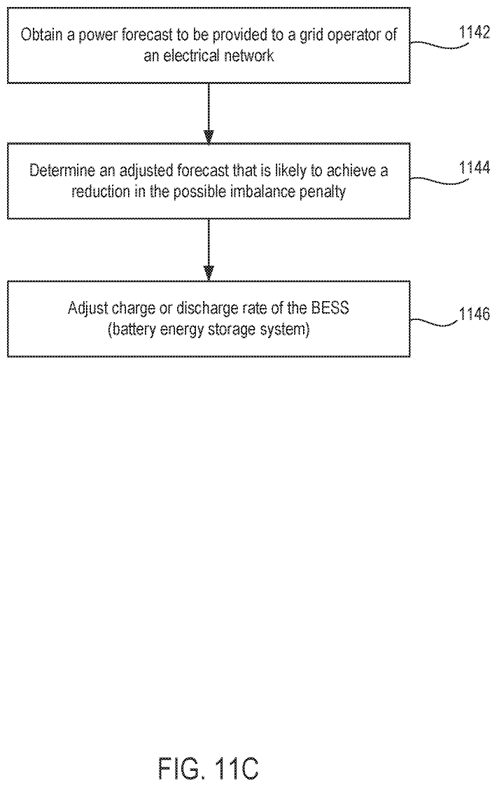

FIG. 11A illustrates an example process according to some embodiments. In step 1102, a power forecast to be provided to a grid operator of an electrical network is obtained. The power forecast may estimate an output of energy for the forecast period from power generation resources associated with an energy producer. In step 1104, determine an adjusted forecast based on an indicator of a deviation of grid frequency from nominal or any measurement of a deviation of grid frequency from nominal during a forecast period. For example, a grid operator (e.g., AEMO) may periodically publish a time series of past frequency indicators which may indicate past deviation of grid frequency from nominal. Adjustments to the frequency forecast or rate of charge/discharge of a battery may be based at least in part on any number of past frequency indicators. In this example, the grid operator may publish the frequency indicators at any time (e.g., every thirty minutes). The publication may include any number of frequency indicators (e.g., each subsequent frequency indicator regarding the grid being every five minutes or any other period). In various embodiments, a regression is performed on any number of the past frequency indicators in determining a forecast of the frequency indicator. It will be appreciated that any statistical or machine learning methodology may be used to use any number of the frequency indicators in forecasting the indicator of grid frequency.

In some embodiments, determining a deviation from nominal grid frequency is a separate process from obtaining a power forecast. Some embodiments include obtaining the power forecast or the determining a deviation from the nominal grid frequency (but not both). As a result, FIG. 11A may not include receiving a power forecast but rather include a step for determining a likely deviation from a nominal grid frequency. Alternately, in some embodiments, FIG. 11A may include receiving a power forecast but not determining a deviation from the nominal grid frequency.

In some embodiments, an entity (e.g., grid operator or other entity) may make measurements and provide measurements indicating a deviation of grid frequency from nominal. These measurements may be used instead of or in addition to frequency indicators as discussed herein for making adjustments to the frequency forecast or rate of charge/discharge of the battery.

In some embodiments, step 1104 may determine if an adjustment needs to be made before determining the adjustment itself and/or any changes in the rate of battery charge/discharge. For example, if there is no deviation from the nominal grid frequency (or the difference is within or below an acceptable threshold), then there may be no adjusted forecast at that time (i.e., no forecast adjustment or rate of battery charge/discharge is determined). If there is a significant deviation from the nominal grid frequency (or the difference is outside of or above the acceptable threshold), then the adjusted forecast or rate of charge/discharge may be determined.

It will be appreciated that, in some energy regimes, imbalance penalties may be periodically published by grid operator (e.g., every five, ten, or fifteen minutes). Adjustments, or an adjustment factor, to the forecasted grid frequency and/or changes to a battery charge/discharge rate may be determined based, in least in part, on these published penalties.

In step 1106, a determination is made whether to achieve a likely reduction of the imbalance penalty by (a) adjusting the power forecast or (b) controlling a battery energy storage system (BESS) associated with the power generation resources. For example, the determination may be made based on a setting or configuration specified by the energy producer.

It will be appreciated that a determination whether to make an adjustment to the power forecast or change the charge/discharge rate of a battery (e.g., BESS) may be made in any number of ways. In some embodiments, the determination may be based on an assessment of profitability of using the battery. The determination may be based on costs of using the battery including, for example, degradation of the energy storage capacity caused by past or current charge/discharge cycles, the physical characteristics of the battery, and/or opportunity costs (e.g., the profits and/or costs of alternative uses of the battery that would not be available if using it for the purposes described in step 1112) may be assessed to determine if the battery should be used. In this example, the trade off of costs and profits may be the determining factor of whether to use the battery storage. In other examples, these trade offs of costs and opportunity of using the battery may be further compared to the costs of adjusting the power forecast to make the determination.

In step 1108, the adjusted power forecast is provided to the grid operator of the electrical network. In step 1110, in response to a determination to achieve the likely reduction in the imbalance penalty by controlling the battery energy storage system associated with the power generation resources, an adjustment to a charge rate or discharge rate of the battery energy storage system is caused to achieve the likely reduction in the imbalance penalty. Many variations are possible, as described herein.

In various embodiments, an adjustment factor may be optimized based on the observed frequency deviations in previous historical periods. In some examples, a historical period can be defined as: a longer period that captures longer-term trends of the frequency deviation and/or a shorter period that captures more short-term trends of the frequency deviation.

FIG. 11B illustrates another example process according to some embodiments. In step 1122, a power forecast to be provided to a grid operator of an electrical network is obtained. The power forecast may estimate an output of energy from power generation resources associated with an energy producer. In optional step 1124, based on a likely deviation from the nominal grid frequency of the electrical network during the forecast period, a forecast adjustment may be inferred that is likely to reduce the imbalance penalty for the forecast period. As discussed herein, the forecast adjustment may be made based on an indicator (e.g., frequency indicator) of a deviation of grid frequency from nominal or any measurements of deviation of grid frequency from nominal during a forecast period.

In some embodiments, step 1126 does not occur unless there is a determination that there is a need to make an adjustment (e.g., based on optional step 1124). In other embodiments, step 1124 is optional, and the method continues to step 1126 without the initial determination if a forecast adjustment is needed.

In step 1126, an adjusted power forecast to achieve the likely reduction in the imbalance penalty is determined based at least in part on the obtained power forecast. In step 1128, the adjusted power forecast is provided to the grid operator of the electrical network.

FIG. 11C illustrates yet another example process according to some embodiments. In step 1142, a power forecast to be provided to a grid operator of an electrical network is obtained. The power forecast may estimate an output of energy from power generation resources associated with an energy producer. In step 1144, a forecast adjustment is determined based on an indicator of a deviation of grid frequency from nominal or any measurement of a deviation of grid frequency from nominal during a forecast period. In this example, a rate of battery charge or discharge may be inferred that is likely to reduce the imbalance penalty for the forecast period. Optionally, there may be a step of determining if the adjusted forecasted is needed as described herein before determining the adjusted forecast.

In step 1146, an adjustment to a charge rate of a battery energy storage system (BESS) associated with the power generation resources is caused to achieve a likely reduction in the imbalance penalty.

FIG. 12 is a block diagram illustrating a digital device in one example. The digital device may read instructions from a machine-readable medium and execute those instructions by a processor to perform the machine processing tasks discussed herein, such as the engine operations discussed above. Specifically, FIG. 12 shows a diagrammatic representation of a machine in the example form of a computer system 1200 within which instructions 1224 (e.g., software) for causing the machine to perform any one or more of the methodologies discussed herein may be executed. In alternative embodiments, the machine operates as a standalone device or may be connected (e.g., networked) to other machines, for instance, via the Internet. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 1224 (sequential or otherwise) that specify actions to be taken by that machine. Further, while only a single machine is illustrated, the term “machine” shall also be taken to include any collection of machines that individually or jointly execute instructions 1224 to perform any one or more of the methodologies discussed herein.

The example computer system 1200 includes a processor 1202 (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 1204, and a static memory 1206, which are configured to communicate with each other via a bus 1208. The computer system 1200 may further include a graphics display unit 1210 (e.g., a plasma display panel (PDP), a liquid crystal display (LCD), a projector, or a cathode ray tube (CRT)). The computer system 1200 may also include alphanumeric input device 1212 (e.g., a keyboard), a cursor control device 1214 (e.g., a mouse, a trackball, a joystick, a motion sensor, or other pointing instrument), a data store 1216, a signal generation device 1218 (e.g., a speaker), and a network interface device 1220, which also is configured to communicate via the bus 1208.

The data store 1216 includes a machine-readable medium 1222 on which is stored instructions 1224 (e.g., software) embodying any one or more of the methodologies or functions described herein. The instructions 1224 (e.g., software) may also reside, completely or at least partially, within the main memory 1204 or within the processor 1202 (e.g., within a processor's cache memory) during execution thereof by the computer system 1200, the main memory 1204 and the processor 1202 also constituting machine-readable media. The instructions 1224 (e.g., software) may be transmitted or received over a network 1226 via network interface 1220.

While machine-readable medium 1222 is shown in an example embodiment to be a single medium, the term “machine-readable medium” should be taken to include a single medium or multiple media (e.g., a centralized or distributed database, or associated caches and servers) able to store instructions (e.g., instructions 1224). The term “machine-readable medium” shall also be taken to include any medium that is capable of storing instructions (e.g., instructions 1224) for execution by the machine and that cause the machine to perform any one or more of the methodologies disclosed herein. The term “machine-readable medium” includes, but should not be limited to, data repositories in the form of solid-state memories, optical media, and magnetic media.

In this description, the term “engine” refers to computational logic for providing the specified functionality. An engine can be implemented in hardware, firmware, and/or software. Where the engines described herein are implemented as software, the engine can be implemented as a standalone program, but can also be implemented through other means, for example as part of a larger program, as any number of separate programs, or as one or more statically or dynamically linked libraries. It will be understood that the named engines described herein represent one embodiment, and other embodiments may include other engines. In addition, other embodiments may lack engines described herein and/or distribute the described functionality among the engines in a different manner. Additionally, the functionalities attributed to more than one engine can be incorporated into a single engine. In an embodiment where the engines as implemented by software, they are stored on a computer readable persistent storage device (e.g., hard disk), loaded into the memory, and executed by one or more processors as described above in connection with FIG. 12. Alternatively, hardware or software engines may be stored elsewhere within a computing system.

As referenced herein, a computer or computing system includes hardware elements used for the operations described here regardless of specific reference in FIG. 12 to such elements, including, for example, one or more processors, high-speed memory, hard disk storage and backup, network interfaces and protocols, input devices for data entry, and output devices for display, printing, or other presentations of data. Numerous variations from the system architecture specified herein are possible. The entities of such systems and their respective functionalities can be combined or redistributed.

1. A computer-implemented method comprising:
obtaining a power forecast to be provided to a grid operator of an electrical network, wherein the power forecast estimates an output of energy from power generation resources associated with an energy producer;
determining a likely deviation from a nominal grid frequency of the electrical network during a power forecast period;
determining whether to achieve a likely reduction in an imbalance penalty by (a) adjusting the power forecast or (b) controlling a battery energy storage system (BESS) associated with the power generation resources;
in response to determining to achieve the likely reduction in the imbalance penalty by adjusting the power forecast:
determining an adjusted power forecast to achieve the likely reduction in the imbalance penalty based at least in part on the obtained power forecast; and
providing the adjusted power forecast to the grid operator of the electrical network; and
in response to determining to achieve the likely reduction in the imbalance penalty by controlling the battery energy storage system associated with the power generation resources:
causing an adjustment to a charge rate of the battery energy storage system to achieve the likely reduction in the imbalance penalty.

2. The computer-implemented method of claim 1, wherein determining the adjusted power forecast comprises:
determining a constant adjustment factor based at least in part on historical deviations of grid frequencies associated with the electrical network; and
determining a first adjusted power forecast by adjusting the obtained power forecast by the constant adjustment factor.

3. The computer-implemented method of claim 2, the method further comprising:
determining a second adjusted power forecast by adjusting a direction and magnitude of the first adjusted power forecast, the direction and magnitude being based at least in part on a forecasted grid frequency deviation at a time of obtaining the power forecast.

4. The computer-implemented method of claim 3, wherein the second adjusted power forecast is calibrated to achieve a pre-defined cumulative imbalance penalty target.

5. The computer-implemented method of claim 1, wherein determining the adjusted power forecast comprises:
generating the adjusted power forecast based on a machine learning model trained against an asymmetric loss function, wherein the machine learning model is trained to penalize over-forecasts or under-forecasts based at least in part on historical deviations of grid frequencies associated with the electrical network.

6. The computer-implemented method of claim 1, wherein determining the adjusted power forecast comprises:
determining that a cumulative error of a plurality of adjusted power forecasts reduces average forecast accuracy below that of a reference forecast obtained from the grid operator; and
halting further adjustments to the power forecast in response to the determination.

7. The computer-implemented method of claim 1, wherein determining the adjusted power forecast comprises:
determining an adjustment factor based at least in part on published imbalance penalties.

8. The computer-implemented method of claim 1, wherein causing the adjustment to the charge rate of the battery energy storage system to achieve the likely reduction in the imbalance penalty comprises:
causing the battery energy storage system to charge based at least in part on a forecast of grid frequency deviation associated with the electrical network and an adjustment factor.

9. The computer-implemented method of claim 1, wherein causing the adjustment to the charge rate of the battery energy storage system to achieve the likely reduction in the imbalance penalty comprises:
causing the battery energy storage system to discharge based at least in part on a forecast of grid frequency deviation associated with the electrical network and an adjustment factor.

10. The computer-implemented method of claim 1, further comprising:
determining that a running cumulative imbalance penalty exceeds a cumulative imbalance penalty target by a threshold amount; and
ceasing further adjustments to the charge rate of the battery energy storage system in response to the running cumulative imbalance penalty exceeding the cumulative imbalance penalty target by the threshold amount.

11. The computer-implemented method of claim 1, wherein the imbalance penalty corresponds to a causer pays factor (CPF) value.

12. A system comprising at least one processor and memory storing instructions that cause the system to perform:
obtaining a power forecast to be provided to a grid operator of an electrical network, wherein the power forecast estimates an output of energy from power generation resources associated with an energy producer;
determining a likely deviation from a nominal grid frequency of the electrical network during a forecast period;
determining an adjusted power forecast to achieve a likely reduction in an imbalance penalty based at least in part on the obtained power forecast; and
providing the adjusted power forecast to the grid operator of the electrical network.

13. The system of claim 12, wherein determining the adjusted power forecast causes the system to perform:
determining a constant adjustment factor based at least in part on historical deviations of grid frequencies associated with the electrical network; and
determining a first adjusted power forecast by adjusting the obtained power forecast by the constant adjustment factor.

14. The system of claim 12, wherein the system further performs:
determining a second adjusted power forecast by adjusting a direction and magnitude of the adjusted power forecast, the direction and magnitude being based at least in part on a grid frequency deviation at a time of obtaining the power forecast.

15. The system of claim 14, wherein the system calibrates the second adjusted power forecast to achieve a pre-defined cumulative imbalance penalty target.

16. The system of claim 12, wherein determining the adjusted power forecast causes the system to perform:
generating the adjusted power forecast based on a machine learning model trained against an asymmetric loss function, wherein the machine learning model is trained to penalize over-forecasts or under-forecasts based at least in part on historical deviations of grid frequencies associated with the electrical network.

17. A system comprising at least one processor and memory storing instructions that cause the system to perform:
obtaining a power forecast to be provided to a grid operator of an electrical network, wherein the power forecast estimates an output of energy from power generation resources associated with an energy producer;
determining a likely deviation from a nominal grid frequency of the electrical network during a power forecast period; and
causing an adjustment to a charge rate of a battery energy storage system (BESS) associated with the power generation resources to achieve a likely reduction in an imbalance penalty.

18. The system of claim 17, wherein the system performs:
determining a schedule for adjusting the charge rate of the battery energy storage system associated with the power generation resources over a time interval; and
providing the schedule for adjusting the charge rate of the battery energy storage system to the grid operator.

19. The system of claim 17, wherein causing the adjustment to the charge rate of the battery energy storage system to achieve the likely reduction in the imbalance penalty causes the system to perform:
causing the battery energy storage system to charge based at least in part on a forecast of grid frequency deviation associated with the electrical network and an adjustment factor.

20. The system of claim 17, wherein causing the adjustment to the charge rate of the battery energy storage system to achieve the likely reduction in the imbalance penalty causes the system to perform:
causing the battery energy storage system to discharge based at least in part on a forecast of grid frequency deviation associated with the electrical network and an adjustment factor.

21. The system of claim 17, wherein the system further performs:
determining that a running cumulative imbalance penalty exceeds a cumulative imbalance penalty target by a threshold amount; and
ceasing further adjustments to the charge rate of the battery energy storage system in response to the running cumulative imbalance penalty exceeding the cumulative imbalance penalty target by the threshold amount.
